(19) United States
(12) Patent Application Publication
(10) Pub. No.: US 2024/0169382 A1
(43) Pub. Date: May 23, 2024

(54) OPINION POLLING SYSTEM, METHOD, AND COMPUTER PROGRAM PRODUCT

(71) Applicant: Think Outloud Co., Georgetown, TX (US)

(72) Inventors: Michele Marie Hermes, Georgetown, TX (US); Kevin Lee Hermes, Georgetown, TX (US)

(73) Assignee: Think Outloud Co., Georgetown, TX (US)

(21) Appl. No.: 17/993,747

(22) Filed: Nov. 23, 2022

(51) Int. Cl. G06Q 30/0201; G06Q 30/0203

(52) U.S. Cl. CPC G06Q 30/0206; G06Q 30/0203

(57) ABSTRACT

Opinion polling systems and methods are described herein. The polling method includes posting a poll to the opinion polling system for display as a poll on user devices and monitoring user parameters associated with a respondent to the poll. The method further includes calculating a user strength score for the respondent based on the user parameters and identifying the respondent as a bot based on the user strength score. Once identified as a bot, the respondent is blocked from further participation on the opinion polling system. In some cases, the method includes calculating a price for purchasing data from the poll based on a volume of the data to be purchased and determining a monetary compensation for the user that posted the poll.

### FIELD OF THE DISCLOSURE

The present disclosure relates to a system, method, and computer program product for conducting, analyzing, and publishing opinion polls and market research.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention. Traditional opinion polling and market research methods are antiquated and fail to meet current expectations of modern technology and fail to keep pace with social trends.

### SUMMARY

According to aspects of the disclosed subject matter, conducting, analyzing, and publishing of opinion polls and market research can be improved through the use of modern technology to meet current demands, provide unique features, and keep pace with contemporary social trends. According to embodiments disclosed herein, an opinion polling system includes a platform for users to create, analyze and publish results of opinion polls. In some embodiments, the platform may include a mobile application downloadable to a mobile device, a server application on a network server, a polling database, and a processor configured to analyze the polling data.

Opinion polling systems and methods are described herein. According to some embodiments, the polling method includes posting a poll to the opinion polling system for display as an active poll on user devices and monitoring user parameters associated with a respondent to the active poll. The user parameters and responses associated with the respondents during the active polling session are stored in association with the polling data and can be accessed after the poll has closed. The method further includes calculating a user strength score for the respondent based on the user parameters to measure the respondent's positive and/or negative impact on the opinion polling respondent community and identifying the respondent as a bot based on the user strength score. The strength score may also be referred to herein as a strength rating for the user. Once identified as a bot, the respondent is blocked from further participation on the opinion polling system.

In some embodiments, an opinion polling system includes one or more processing circuitries configured to select a first category to be associated with a poll and post the poll for display as an active poll on user devices based on the first category matching a user preferred category associated with polls to be displayed on the user devices. The system further includes identify a same user preferred category associated with respondents to the active poll, the same user preferred category being different from the first category and selecting the same user preferred category as a second category to be associated with the active poll. Once the second category has been selected, the method includes displaying the active poll to another user device based on the second category matching a user preferred category associated with polls to be displayed on the other user device.

Users may also purchase data from a selected poll. For example, a pollster may decide to purchase live data of an active poll based on selected criteria. However, poll data may also be purchased after the poll has closed. In some embodiments, the pollster may select criteria to determine what data from the active poll is to be purchased. For example, certain criteria may be selected by the pollster to purchase a subset of the current aggregated data based on demographics (e.g., age group, women, men, zip code, geographic region, political affiliation, religious affiliation, income range and the like). According to some embodiments, a user may purchase data by initiating an instant purchase and be directed to a checkout page or the user may set buy requests for the opinion polling system to automatically purchase live data of one or more desired polls based on predetermined criteria (e.g., at the end of each day of polling).

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates a user device and a functional block diagram of an opinion polling system connected via a network, during a poll drafting session, according to one or more exemplary aspects of the disclosed subject matter;

FIG. 2 illustrates a polling screen according to one or more aspects of the disclosed subject matter;

FIG. 3 is a flow chart of an opinion polling method according to one or more aspects of the disclosed subject matter;

FIG. 4A illustrates a user device and a functional block diagram of the opinion polling system connected via a network, during a response session, according to one or more aspects of the disclosed subject matter;

FIG. 4B illustrates a user device and a functional block diagram of the opinion polling system connected via a network, during a result session, according to one or more aspects of the disclosed subject matter; and

FIG. 5 is a functional block diagram illustrating a user device connected to a networked system of one or more networked computers and servers, according to some exemplary aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

Referring now to the drawings, wherein like reference numerals designate identical or corresponding parts throughout the several views:

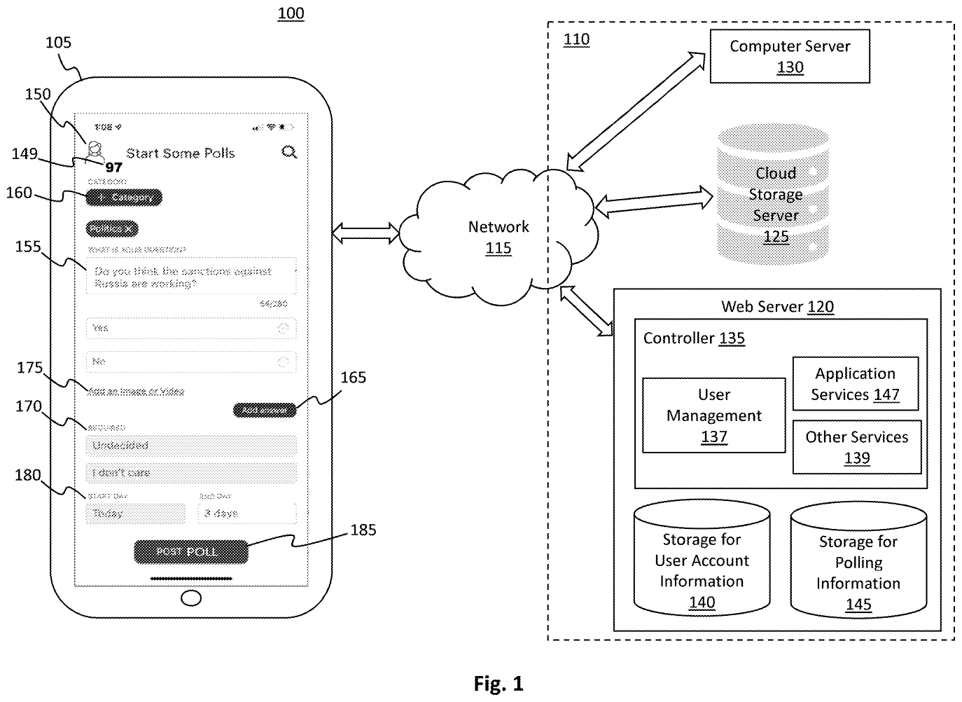

FIG. 1 is a block diagram of a user device 105 connected via a network to an opinion polling system 110 during a poll drafting session 100 according to one or more exemplary aspects of the disclosed subject matter. The user device 105 and the opinion polling system 110 may be connected to each other through a network 115.

User device 105 may be a smart phone, a personal computer (PC), a desktop computer, laptop computer, notebook computer, tablet computer, netbook computer, a personal digital assistant (PDA), or any other programmable electronic device capable of communicating with other devices on network 115.

Opinion polling system 110 may include, but is not limited to, web server 120, cloud storage server 125, and computer server 130. It should be appreciated that the polling system 110 may be a centralized system contained within a private network or may be a distributed cloud-based system distributed over any combination of private and public networks.

Network 115 may be, for example, a local area network (LAN), a wide area network (WAN) such as the Internet, or a combination of the two, and may include wired, wireless, or fiber optic connections. In general, Network 115 can be any combination of connections and protocols that support communications between two or more computers and related devices.

The web server 120 is a computer system that manages user data and polling data through one or more applications running on the user device 105. Specifically, the web server 120 serves as an infrastructure system (platform) that manages polling services provided from various types of computer servers 130 and/or cloud storage servers 125 according to the users of the user devices 105. The web server 120 includes a controller 135, which is provided with a CPU, a RAM and a ROM, a storage section for user information 140, and a storage section for polling information 145.

The controller 135 can be utilized to download and configure an application on the user device 105, for example, during an enrollment process of the user for the opinion polling system 110. The controller 135 also controls the communications between the user device 105, the web server 120 and/or the computer servers 130. According to some embodiments, the controller 135 comprises user management section 137, application services section 147, and other services section 139.

The user management section 137 is configured to track and associate user data (e.g., account information, user preferences, user polls, user strength score 149, and the like. According to some embodiments, the user management section 137 cooperates with the storage for user account information 140 and/or the storage for polling information 145 to store the user data for the opinion polling system 110. In some embodiments, the user management section 137 cooperates with the cloud storage server 125 to track and maintain polling data of the users. In some embodiments, the user management section 137 cooperates with the application services section 147 to control access to the user account information and the polling information for authenticating the user during registration and/or login and for controlling features of the opinion polling system 110 for polls.

The storage section for user information 140 exchanges user information between the user device 105 and one or more of the computer server 130 and/or cloud storage server 125. The storage section for user information 140 may contain data related to the user of the user device 105 such as user profile information, user demographic information, user preferences, or the like.

The process begins with the user device 105 logging into the web server 120. The web server 120 then challenges the user device 105 in order to authenticate the user device 105 and/or enroll the user. The authentication process and/or enrollment process may be managed by the web server 120 as an application service 147 and/or use a third-party authentication service hosted, for example, on the computer server 130. In addition, to authentication, the web server 120 may provide updated user profile information and/or user strength score 149 to display on the user device 105. The updated user profile information and/or user strength score 149 may be accessed, for example, on an account profile screen of the user or on an administrator screen, according to some embodiments. During authentication, the user strength score 149 may be used to identify a bot account or bot activity. In some embodiments, updated user profile information and/or user strength score 149 may be displayed with a user icon 150 on the user device 105 during the poll drafting session 100. However, in some embodiments, the user strength score 149 may not be displayed.

Once authenticated, the user can initiate the poll drafting session 100 by selecting a menu item from the opinion polling application loaded on the user device 105. In the poll drafting session 100, the user can start a poll by entering a question into the polling question field 155. In some embodiments, the question may be entered by the user typing in the question field 155 or the user may select, for example, from a drop-down list of recent questions entered by the user.

The user may select the category button 160 to add one or more categories for the poll to be tagged in. For example, the category “Politics” may be added by the user selecting the category from a predetermined list. Examples of categories in the predetermined list include but are not limited to, Animals, Art, Business, Controversy, Economy, Education, Employment, Entertainment, Family, Fashion & Beauty, Film, Finance, Food & Beverage, Fun, Government, Health & Medicine, International, Law, Media, Music, Philosophy, Politics, Recreation, Science, Religion, Society, Sports, Technology, Transportation, Travel, TV, and Other. In some embodiments, the opinion polling system 110 may determine another category to be selected for the poll based on trending criteria such as keywords entered in the search field 225, data collected during advanced searches 230, trending news, Really Simple Syndication (RSS) feeds, a popular quote by someone famous, a holiday season or calendar event, and the like. According to some embodiments, the opinion polling system 110 can determine to add a category based on the trending criteria meeting or exceeding a predetermined threshold, the trending criteria coming from a desired news source or RSS feed, and/or a critical date associated with an event or holiday season. The dynamically selected categories may also be dynamically unselected based on the trending criteria no longer exceeding the predetermined threshold, a predetermined number of calendar days, and/or a critical date associated with an event or holiday season having passed.

Once the question has been entered, the user can add answer choices by selecting the answer button 165 and entering text into a pop-up answer choice field. Once entered, the answer choice is added to the list of answer choices for the poll. In some embodiments, one or more of the “Required” answer fields 170 is added to the list of answer choices for the poll. In some embodiments, one or more default answers (e.g., “Undecided,” and “I don't care”) are automatically added by the opinion polling system 110. In some embodiments, suggested answer choices may be automatically recommended and/or added based on user preferences and/or by the type of question entered by the user. According to some embodiments, the answers may be displayed as a multiple-choice answer. For example, if the user enters the question: “What is your biggest concern for our country, right now?” the multiple-choice answers may include: “Inflation,” “gas prices,” “grocery bills,” “potential wars,” and the like.

The user may also add an image, video, and/or audio to the poll. In some embodiments, the user may add a video and/or audio by selecting a media link 175 to select from recorded images, video, and/or audio. In some embodiments, the media link 175 may activate a camera and/or a microphone of the user device 105 to record the desired images, video and/or audio.

According to some embodiments, a start time and an end time for the poll to be active may be defined by the user. According to an embodiment, the user may enter specific dates and times in start and end fields 180 displayed on the user device 105.

Once the user is satisfied with all of the selections made for the poll, the user may activate the poll by selecting the “Post Poll” button 185. As such, the poll is posted via the opinion polling system 110 to personal feeds of each user following the selected categories, following the user who posted the poll, targeted user advertisements, and the like. A user who posts a poll may also be referred to herein as a pollster or polling user. According to some embodiments, the storage for polling information 145 stores the selections and entries made from the user device 105 for each corresponding poll in association with the user's account information stored in the storage section for user information 140. Other users' responses to each poll may be stored in the cloud storage server 125 along with analytics of the aggregated response data, according to some embodiments. The associated data may be managed by the user management section 137 to track the associated data of the user account information 140, the storage polling information 145, and/or the cloud storage server 125, in accordance with some embodiments.

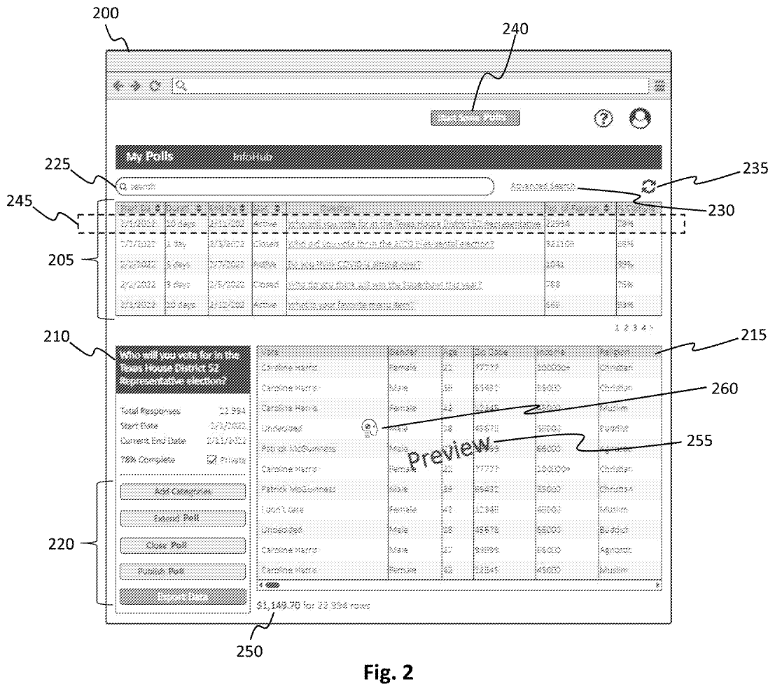

FIG. 2 illustrates an active polling screen 200 of a subscription website of the opinion polling system 110, according to some embodiments. Although some features of the opinion polling system 110 are illustrated and described with regard to a mobile application loaded on the user device 105, any of the features of the mobile application may be accessed through the subscription website and may be formatted for display on other user devices (e.g., PC, laptop, tablet, or the like). Furthermore, the features of the subscription website may also be accessed through the mobile application and may be formatted for display on one or more screens of the user device 105 (e.g., mobile phone, smart phone, or the like).

According to some embodiments, the active polling screen 200 includes a listing of polls 205, a poll summary 210 and a preview pane 215 of a selected poll 245. The data displayed within the preview pane 215 may be displayed with a watermark 255 overlaying the data.

The listing of polls 205 may be determined based on categories followed, an entity that the user belongs to (e.g., work, church, organization, city, or the like), polls posted by the user accessing opinion polling system 110 from the user device 105, polls posted by other users with access to opinion polling system 110 from the user device 105, and/or polls recommended for the user by the opinion polling system 110. The listing of polls 205 may include summary information about each of the polls including: start date, end date, duration, status, polling question, number of responses, % completed demographic information, categories, number of likes, number of dislikes, or other summary information. According to some embodiments, the listing of polls 205 can be set by the user to display a certain number of polls (e.g., 10, 25, or 50) and the listing of polls 205 can be sorted and filtered by the user using an advanced search which allows the user to view and analyze the responses to each of the listed polls.

The poll summary 210, according to some embodiments, displays further details of the selected poll 245. For example, the poll summary 210 may display the polling question, a total number of responses, a start date, an end date, a percentage of polling complete, or other summary information, one or more poll edit buttons 220, and/or a price 250 calculated for exporting data from the selected poll 245.

The preview pane 215 may include a list of responses to the selected poll 245. According to some embodiments, the list of responses displayed in the preview pane 215 include responses from a random selection of participants that is representative of a cross-section of the total respondents who participated in the selected poll 245. In some embodiments, data in one or more of the fields of the preview pane 215 may be obscured from view depending on the user's authorization level. For example, a participant's name or contact information may be obscured in the preview pane 215 for a user with basic authorization. Whereas, in a case where the user has administrative authorization, the data in the one or more fields of the preview pane 215 may not be obscured from view. In some embodiments, the data to be displayed in the preview pane 215 may be determined in part by desired fields selected by the user for display. For example, a user may desire to view only a random selection of respondents' data based on zip code, gender, and/or age group. As such, a random selection of respondents' data that meets the criteria of the desired fields selected by the user is displayed in the preview pane 215.

According to some embodiments, the list of responses may include a bot indicator 260 associated with certain responses determined by the opinion polling system 110 to have been generated by a bot (e.g., social media bot). The opinion polling system 110 screens the responses to determine whether any of the responses have been generated by a bot based on a user strength score 149 associated with a given response. In some embodiments, a bot score may be calculated for one or more responses to polls and/or based on other bot activity. For example, a bot score may be calculated based on one or more user parameters associated with the responses, wherein the user parameters include, but are not limited to: a number of comments posted, a number of re-posts, a number of likes, a number of dislikes, a number of categories followed, a frequency of polling, a frequency of commenting, and a number of followers.

The bot indicator 260 may be displayed based on the bot score meeting or exceeding a predetermined threshold, in accordance with some embodiments. As such, a pollster may filter the list of responses to remove any responses determined to be associated with a bot prior to purchasing the poll data. In some embodiments, the opinion polling system 110 is configured to automatically remove any responses identified as having been generated by a bot. In some embodiments, the polling data may be filtered to separate the list of all responses including a bot indicator from the rest of the polling data. In such scenarios, a separate report may be generated for the opinion polling system 110 to add the user identified as a bot to a block list to prevent the bot from responding to any other polls.

The poll edit buttons 220 may include, but are not limited to, an add categories button, an extend polling date button, a close polling button, a publish polling results button, mark poll as private button, and an export data button. In some embodiments, a price calculated 250 for exporting current or selected data is also displayed in the polling screen 200. The price calculated 250 may be based on the total number of rows of polling data selected for export and a predetermined price-per-row as established by a user's subscription level for exporting the data. According to some embodiments, the price calculated is based on the most current data available. For example, during an active poll, the price 250 and the number of rows of data for the selected poll 245 may be updated on a real-time or near real-time basis, and when a user selects the refresh button 235. A final price 250 may be displayed after the poll has been closed. In real-time or near real-time are used herein and are intended to be understood as a time including acceptable transmission delays associated with networks and acceptable delays associated with storing, retrieving, and/or processing of data.

The polling screen 200 may also include a search field 225, an advanced search button 230, a refresh button 235, and/or a start poll button 240. The search field 225 allows a user to search for active and/or past polls. In some embodiments, the search field 225 allows for entry of keywords, pollsters, topics, categories, or the like to be searched within the database to identify active or past polls. The advanced search button 230 may initiate the pop-up of an advanced search menu for the user to input any combination of desired search criteria and other parameters to be used for searching the database. In this manner, the user can sort and filter the listing of polls 205. In some embodiments, the desired search criteria and other parameters entered can be saved or bookmarked for use in future searches. Advanced Search criteria can include, but is not limited to, user demographic information, number of votes, polling status, polling categories, polling start and end dates, number of poll likes and dislikes, minimum percentage of completed demographics, poll status, and the like. The refresh button 235, once selected by the user, refreshes the listing of polls 205 according to the most current data available. The start poll button 240 launches the poll drafting session 100 (e.g., as shown in FIG. 1).

In some embodiments, the opinion polling system 110 may indicate a high volume of responses coming from other users that follow a category that had not been selected for a given poll. In such a case, the opinion polling system 110 may issue a recommendation to the pollster to add the new category during the active poll. According to some embodiments, adding the recommended category to the active poll initiates the opinion polling system 110 to insert the active poll to users feeds who are following the added category and/or prompts these users to view the active poll. As such, the active poll may be exposed to users following the added category who may have a high interest in participating in the active poll but otherwise may not have seen the active poll. According to some embodiments, once a poll has been posted and activated, one or more categories can be added to the active poll by selecting categories from a predetermined list. In some embodiments, once a category has been added and the poll is an active poll, the category may not be removed.

According to some embodiments, the opinion polling system 110 may send notifications to users that follow the added category of the active poll but have not yet participated in the active poll. Such a notification may provide a summary of the active poll to these other users. The notification may include information such as a preview of the active poll, a number of other users following the recommended category that have already participated in the active poll, a trending score for the active poll, a percentage of polling complete for the active poll, and/or other like information.

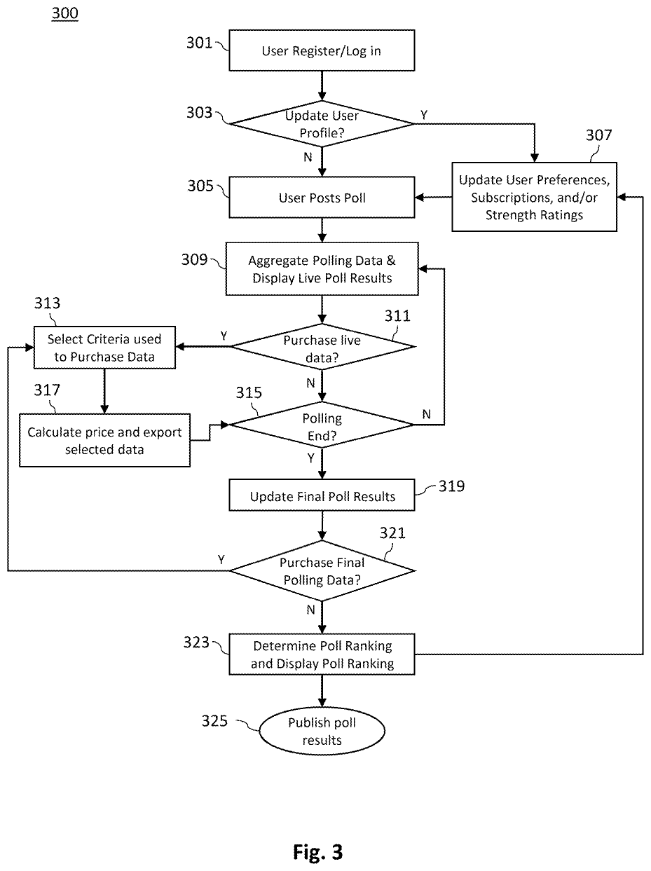

FIG. 3 is a flow chart of an opinion polling method 300, according to some embodiments. The method begins at step 301 with a user registration and/or login. During registration, a user can be prompted to enter basic account information, demographic information, other communication services, and/or user preferences. Examples of basic account information include but are not limited to, name, phone number, email address, physical address, payment options, user role (e.g., administrator, manager, contributor), and the like. Examples of other communication services include but are not limited to, e-mail, SMS, text, voice mail, social media posts, or the like. Examples of demographic information include but are not limited to, gender, employment status, income level, race, birth date, zip code, living arrangement, marital status, sexual orientation, level of education, political affiliation, religious affiliation, income range, registered voter status, and home ownership status. Examples of user preferences include but are not limited to, categories to follow, interests, pollsters to follow, entities to follow, and the like. During login, the user may be authenticated by the opinion polling system 110 and/or via a third-party service (e.g., a cloud-based authentication service, authentication as a service (AaaS)). Authentication may include features such as Captcha, and two-factor authentication.

At step 303, once a user has been registered and/or after the user has logged in, the user may be prompted to update or may choose to update their user profile. In addition, if an initial user strength score 149 has not been established for the user, the opinion polling system 110 may assigned a rating based on: the user's number of followers, the number of invites that the user has sent and have been accepted by other users, the user's subscription level, or any other criteria that would be indicative of a user strength score 149. According to some embodiments, a user strength score 149 may be an assigned value that is between 1 and 100. However, any suitable range of values may be used for the user strength score 149. In some embodiments, an initial user strength score 149 of 1 may be assigned to each user upon registration.

In the event that the user does not elect to update their profile, the method advances to step 305. In the event that the user elects to update their user profile, the method continues to step 307 where the user can modify their basic account information, demographic information, preferences, subscription services and/or the like. According to some embodiments, the opinion polling system 110 may update the user strength score 149 or strength rating based on the any modifications made to the user's profile and/or any recent activity (e.g., posting polls, sharing polls, commenting on polls, likes received, and dislikes received). The user strength score 149 may be determined using one or more of the parameters listed in Table 1. According to some embodiments, the user strength score 149 may be positively impacted (e.g., given a higher rating) based on the total number of polls posted by the user, a ratio of the number of likes to dislikes being above a predetermined threshold, a completeness of the demographic data of the user, a longevity of a user being registered with the opinion polling system 110, a relatively high frequency of polling and commenting (e.g., activity indicative of an active user), number and/or amount of polling data being purchased, and/or verification of the user's status. According to some embodiments, the user strength score 149 may be negatively impacted (e.g., given a lower rating) and/or bot activity may be determined based on a number of comments the user has posted, number of re-posts from other users, a ratio of likes to dislikes being below a predetermined threshold, a number of categories followed, a relatively low frequency of polling and commenting (e.g., activity indicative of a passive user), and/or number of followers.

According to some embodiments, the user strength score 149 can be used during authentication of a user to detect a bot account or bot activity. One or more of the parameters can be used as a weighting factor in an algorithm to determine a final strength score for the user. In some embodiments, the higher the score, the more likely the user account is a genuine user and not a bot account. A higher final strength score is also indicative that the user is providing qualitative data and/or quantitative data. Furthermore, the user strength score 149 enables a pollster to filter their exported data to only include data from users that are providing quality data and to avoid paying for irrelevant or meaningless data and/or data that is generated by bots. In some embodiments, the opinion polling system 110 may be configured to exclude or filter a bot generated response from the summary of responses. In some embodiments, the user strength score 149 or strength rating may be used to determine a user's monetary compensation for data purchased from the user's poll. Once the user has modified their preferences and/or the user strength score 149 has been updated at step 307, the method continues to step 305.

TABLE 1

| Parameter | General Information |
|---|---|
| Number of polls the user has | Higher number of posted poll polls |
| posted | will increase the strength rating. |
| Number of comments the user has | Lower impact on rating. |
| posted | |
| Number of re-posts from other | Lower impact on rating. |
| users | |
| Overall rating of the user's posted | Ratio that indicates a higher |
| polls (likes v. dislikes) | strength rating if the likes are |
| | more abundant. |
| Overall rating of their posted | Lower impact on rating. |
| comments on other person's polls | |
| (likes v. dislikes) | |
| Number of categories followed | Lower impact on rating. |
| Completeness of their demographic | Significantly increases the rating. |
| data | |
| Longevity with the Poll platform | Long-term users get a higher |
| | rating. |
| Frequency of poll and comment | Daily active user v. passive user |
| posting | gets a higher rating. |
| Number of polls purchased | The more poll data purchased through |
| | the SaaS site gets a higher rating. |
| Number of followers | Lower impact on rating. |
| Verified user status | Significantly increases the rating. |
| Number of new user invitations | Increases the rating |
| who register for an account in | |
| the opinion polling system 110 | |

At step 305, the user can post a poll as described above with regard to FIG. 1. According to some embodiments, when the user posts the poll, the opinion polling system 110 may send notifications to other users of the system and/or other media sites. In some embodiments, the opinion polling system 110 can limit the viewing of the poll to users that match a target demographic within a predetermined degree of matching. In such embodiments, the opinion polling system 110 determines a degree of matching for the target demographic of the responses received. In some embodiments, the opinion polling system 110 may be configured to interact with other service providers of the user to send notifications via one or more digital communication services (e.g., e-mail, SMS, text, voice mail, social media posts, or the like). In some embodiments, the poll can be posted as an active poll in the opinion polling system 110 and notifications can be sent via the one or more digital communication services in a single click of the post poll button 185. Such notifications may include the poll question, the answer options, the number of re-posts, a number of shares, a number of bookmarks, or the like. Such notifications may also provide an internet link to the opinion polling system 110 at which a recipient of the notification can view and/or respond to the poll. As such, the polls can be exposed to people who are not yet registered with the opinion polling system 110. The opinion polling system 110 may limit sending of such notifications to users that do not match a target demographic (e.g., geographic region, zip code, county, state, or country) within the predetermined degree of matching in accordance with some embodiments. Upon receiving a response to the poll, the opinion polling system 110 can attempt to authenticate the respondent as a registered user of the system and/or prompt the respondent to register.

At step 309, the controller 135 aggregates the data collected from the responses to the poll and stores it in the storage polling information 145 and/or the cloud storage server 125. According to some embodiments, as the data is collected for an active poll, the aggregated data may be displayed in real-time or near real-time on the polling screens 200 of the pollster's user device 105 and on user devices 105 of other users. The aggregated data may be displayed in real-time or near real-time on any of the screens described herein without limitation. Although some examples are described with regard to the website application of the opinion polling system 110 and other examples are described with regard to a mobile application, it is to be understood that any of the data may be displayed on any screen and/or any number of screens of the website application or the mobile application, without limitation. In some embodiments, a poll hosted by the opinion polling system 110 may be displayed on several screens of the user device 105. In some embodiments, some of the summary data aggregated for the poll may be displayed with the notifications sent via the one or more digital communication services. For example, the notification for the poll may include the polling question, the total number of responses, the start date, the end date, the % completed demographic information, and/or a private poll indicator. If a poll is marked as private, only authorized users can access the polling data. If a poll is marked public, any user can purchase and export data from the poll.

According to some embodiments, notifications may also include an award for a respondent to register with the opinion polling system 110 and/or participate in the active poll. Examples of awards include but are not limited to, monetary compensation, coupons, tickets to events, points redeemable for merchandise and/or services, or the like. In some embodiments, the awards may be redeemed through the pollster, a polling entity, a merchant, a service provider, or the like. In some embodiments, the online polling system 110 tracks the awards for each of the users and provides a digital coupon that is redeemable at the merchant store and/or service provider or credits monetary compensation to a user's account. In some embodiments, the credits for monetary compensation may be paid via an online banking service associated with the user's account or may be paid via a third-party online payment service (e.g., Paypal™, Zelle™, Venmo™, or the like).

At step 311, a pollster and/or a user of the opinion polling system 110 may decide to purchase live data of the active poll. In the case that the decision is to purchase live data, the advances to step 313 and in the case that live data is not being purchased, the system advances to step 315.

At step 313, criteria may be selected by the user to determine what data selected from the active polls is to be purchased. In some embodiments, criteria may be set to purchase a subset of all of the current aggregated data. For example, certain criteria may be selected by the user to purchase a subset of the current aggregated data based on one or more target demographics (e.g., age group, women, men, zip code, political affiliation, religious affiliation, income range and the like).

According to some embodiments, a user may purchase data by initiating an instant purchase and be directed to a checkout page or the user may set buy requests for the opinion polling system 110 to automatically purchase live data of one or more desired polls based on predetermined criteria.

In some embodiments, the user may set one or more buy requests when the % completed demographic information reaches certain thresholds. For example, the user may set a first buy request when the % completed demographic information reaches 25%, a second buy request when the % completed demographic information reaches 50%, a third buy request when the % completed demographic information reaches 75%, and a fourth buy request when the % completed demographic information reaches 100%.

In some embodiments, the user may set buy requests based on escalating thresholds. For example, the user may set an initial buy request for when the total number of responses exceeds an initial threshold (e.g., 1,000 responses) and each threshold thereafter may be determined based on a predetermined function of the threshold used for the previous buy request. For example, a second threshold may be determined for a second buy request based on a value that is double the initial threshold (e.g., 2,000 responses), a third threshold may be determined for a third buy request based on a value that is double the second threshold (e.g., 4,000 responses), a fourth threshold may be determined for a fourth buy request based on a value that is double the third threshold (e.g., 8,000 responses). The buy requests may use an escalating threshold in this manner until the poll ends.

According to some embodiments, the buy requests may be set to purchase based on dates and/or times. For example, the buy requests may be set to purchase at the end of each day, at the end of a select day(s) of the week (e.g., Mondays, weekdays (M-F), or weekend days (Sa, Su)), at the end of a month, dates associated with specific events (e.g., political conventions, debates, elections, sporting events, concerts, media launch, holidays, or the like), and/or at a certain times of the day (e.g., 8 am, 5 pm, 9 am, 9 pm, or the like).

At step 317, once the criteria to be used for purchasing the data has been selected, the fees for the data purchase is calculated and the selected data is exported. According to some embodiments, the fees may be calculated based on the number of rows of data being purchased and based on a user's subscription level. In some embodiments, a user may select data from more than one row of the listing of polls 205. In some embodiments, users may purchase a tiered subscription service (e.g., $0/month, $29/month, $99/month, or custom pricing) that allows the user to purchase at a set tiered price-per-row of data (e.g., $0.20, $0.12, $0.07, and custom pricing), respectively. For example, the higher the subscription level is, the less the price-per-row is.

Based on this calculation, the total price for the data selected is shown on the polling screen 200 as the price calculated 250. Once the price has been calculated, the selected data can be purchased by the user manually selecting the export data button or may be automatically purchased by the opinion polling system 110 based on the threshold criteria determination made at step 311. According to some embodiments, the selected data is exported to the cloud storage server 125 in a suitable data format (e.g., .csv) for real-time or near real-time access, or future access by the user. In some embodiments, the selected data is exported to a user storage device connected to the network 115.

At step 315, the opinion polling system 110 determines whether polling has ended for the selected poll. If polling has not ended, the method returns to step 309 and continues to aggregate polling data and displaying live results to the users. According to some embodiments, the pollster or an authorized user for an active poll can extend the original end date (e.g., extend 30 days) or can choose to end polling for the active poll prior to the original end date. If polling has ended for the selected poll, the method continues to step 319.

At step 319, the opinion polling system 110 updates the final polling results for the selected poll. In some embodiments, the price calculated 250 is determined based on the user criteria and/or subscription level and a total number of selected rows. The price calculated 250 and total number of selected rows are displayed on the polling screen 200 or another user device supporting usage of mobile applications (e.g., smartphone, tablet or the like).

At step 321, the system determines whether final polling data is to be purchased. If the final polling data is to be purchased, the method continues to step 313 to select and/or update criteria used to purchase the final polling data. Then, the method continues to step 317 to re-calculate the price based on any updated criteria and the selected data is exported. If at step 321, the system determines that no further final polling data is going to be purchased, the method advances to step 323.

At step 323, the opinion polling system 110 determines a ranking for the selected poll. According to some embodiments, the ranking of the poll may be determined based on polling statistics of the active poll and/or after the poll has ended. Examples of polling statistics include, but are not limited to, number of respondents, number of likes, number of dislikes, number of comments, number of users following the poll, number of users purchasing poll data, volume of data purchased, and total dollar amount of poll data sold. Once the poll ranking has been determined, the poll ranking may be used at step 307 to re-calculate and update the user strength score 149. A trending status of poll may be determined based on activity and polling statistics associated with the poll as compared to that of other polls. A poll may remain trending, even after it has been closed, based on continued activity and accumulation of polling statistics of the poll. Further rankings may be developed for the polls based on historical trending status and polling statistics (e.g., the greatest number of respondents, the greatest amount of data purchased, greatest number of users enrolled from poll notifications, and the like). Poll rankings can also be based on category, geographical location (e.g., country, state, county, zip code, and the like), or demographics. In some embodiments, pricing may be calculated based on a degree of matching criteria (e.g., a degree of matching for a target demographic).

At step 325, the final results of the poll may be published and/or shared with other users. In some embodiments, the final results may be published to the user's device 105 and/or they may be shared in a notification sent via the one or more digital communication services. In some embodiments, the user is able to select which demographic percentages to share in the publication and/or add a description to be shown with the selected poll results. Data from the poll results may be purchased by other users. According to some embodiments, the user who created the poll is compensated for the other users' purchases of the polling data. In some embodiments, the compensation may be based on a percentage of the volume of data purchased (e.g., cost-per-row). In some embodiments, the compensation may be based on the user strength score 149. For example, the higher a user strength score 149 is, the higher the compensation is for data purchased from a user's poll. In some embodiments, the user strength score 149 may be used as a weighting factor for determining the monetary compensation based on a volume of data purchased from the user's poll. In some embodiments, the user strength score 149 may be used to determine a re-occurring award (e.g., daily, weekly, monthly, annually) for polls that gain the most shares, the most likes, polls that result in the most new subscribers, or the like.

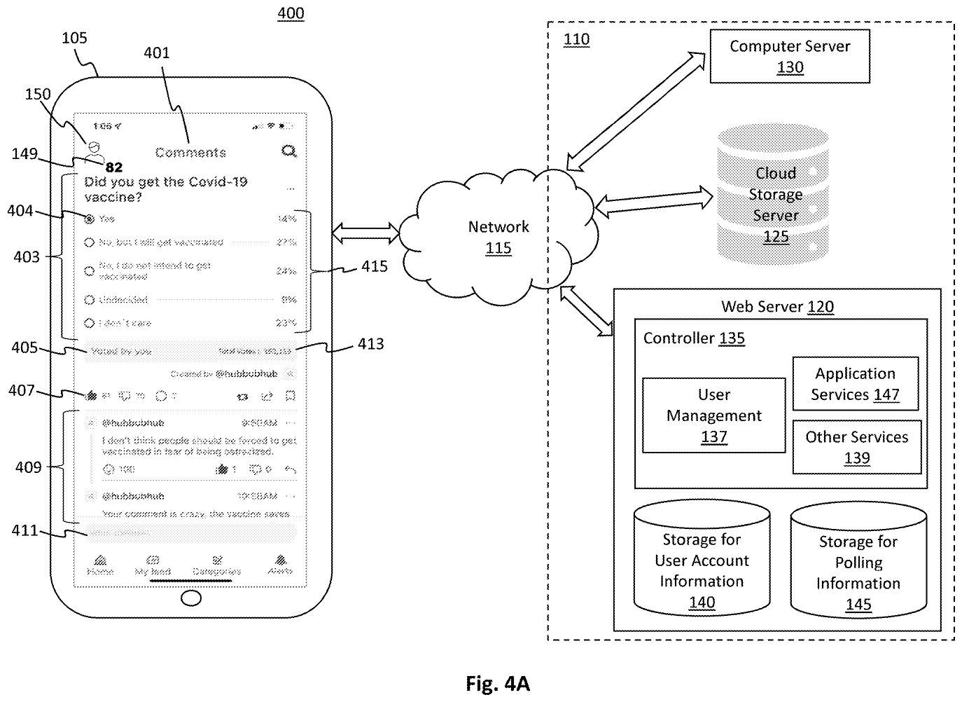

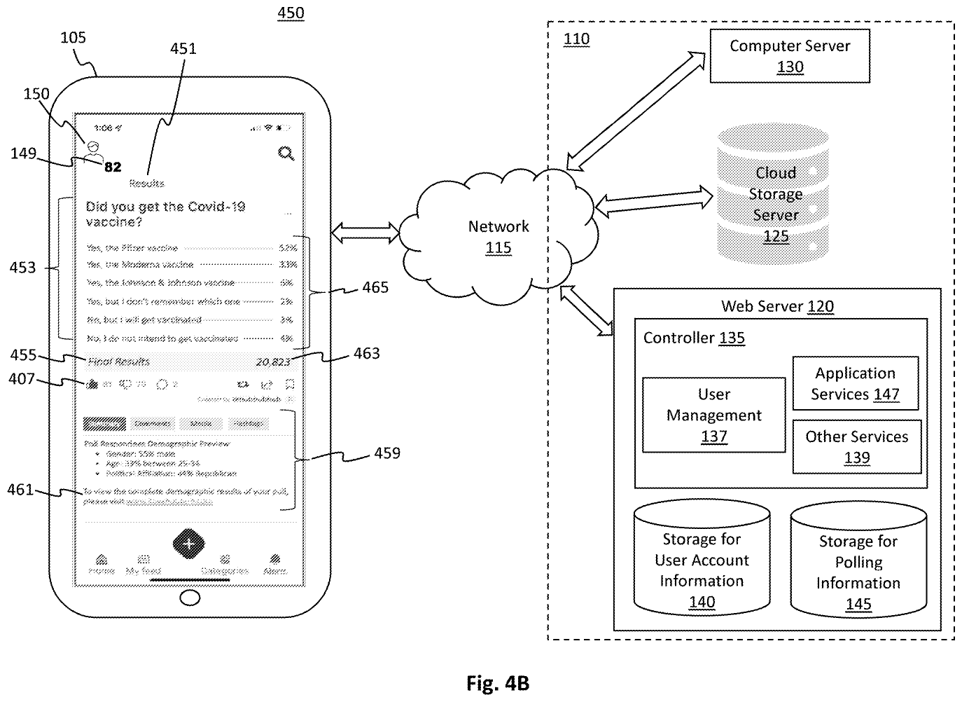

FIG. 4A is a block diagram of a user device 105 connected via the network 115 to the opinion polling system 110 during a response session 400 according to one or more exemplary aspects of the disclosed subject matter. FIG. 4A is similar to FIG. 1 except the user device 105 shows a comments screen 401 of another user responding to a poll according to some embodiments. The comment screen 401 may show the user icon 150 and the user ranking 149, a poll summary section 403, a personal response indicator 404, a personal voting status 405, like, dislike, and comment indicators 407, a comment section 409, a comment field 411, and a total votes indicator 413. According to some embodiments, the poll summary section 403 includes the polling question, radial buttons for marking a desired response to the poll, and response distribution values 415. Once the personal response indicator 404 has been selected by the user from the radial buttons, the personal voting status 405 is updated to reflect the user's status. Enabling opinion polling through social media can expand the audience to a diverse group of individuals which can be reflected in the demographic data collected and displayed in the response distribution values 415 (e.g., count breakdown by answer choice). According to some embodiments, the commentary in the comments screen 401 may not be downloadable which allows for users to remain anonymous.

According to some embodiments, poll participants or respondents in a poll can be compensated for their participation in the poll. When users post polls that get downloaded by subscription website users, the user that created the poll is compensated with cash rewards for the purchase of the on-demand download of the data. For example, if a mobile application user creates a poll that captures the interest of 3 parties that want to download the on-demand data, that user will get rewarded with a percentage (e.g., 2%) of the pay-per-row download cost incurred by the subscription website user. In such a case, if the poll costs the subscriber $400, the user who posted the poll would be compensated with $8. If the poll is downloaded by other subscribers (e.g., 5 times), the user would be compensated for each of the other subscriber's downloads (e.g., 5×$8=$40). In another example, the cost to the subscriber of the pay-per-row download of the poll results is $4,000. In this scenario, the user who posted the poll would be compensated with $80 for one download. If the poll is downloaded by other subscribers (e.g., a total of 4 times), the user who posted the poll would receive a total cash reward of $320.

FIG. 4B is a block diagram of a user device 105 connected via the network 115 to the opinion polling system 110 during a result session 450 according to one or more exemplary aspects of the disclosed subject matter. FIG. 4B is similar to FIG. 4A except that user device 105 shows a results screen 451 of the other user viewing results of a poll that has been closed, in accordance with some embodiments. The results screen 451 may show the user icon 150 and the user ranking 149, a final results summary section 453, a final result status 455, like, dislike, and comment indicators 407, a demographic preview section 459, a link to the complete demographic data 461, and a final votes indicator 463. According to some embodiments, the final results summary section 453 includes the polling question, listing of responses to the poll, and final response distribution values 465. In some embodiments, the final response distribution values 465 (e.g., percentage breakdown by response). According to some embodiments, the preview summary information displayed in the demographic preview section 459 may be bookmarked for future access. In some embodiments, the preview summary information of the demographic preview section 459 may be provided with the link to the complete demographic data 461 in a notification to other users (e.g., via SMS) and/or may be posted to social media.

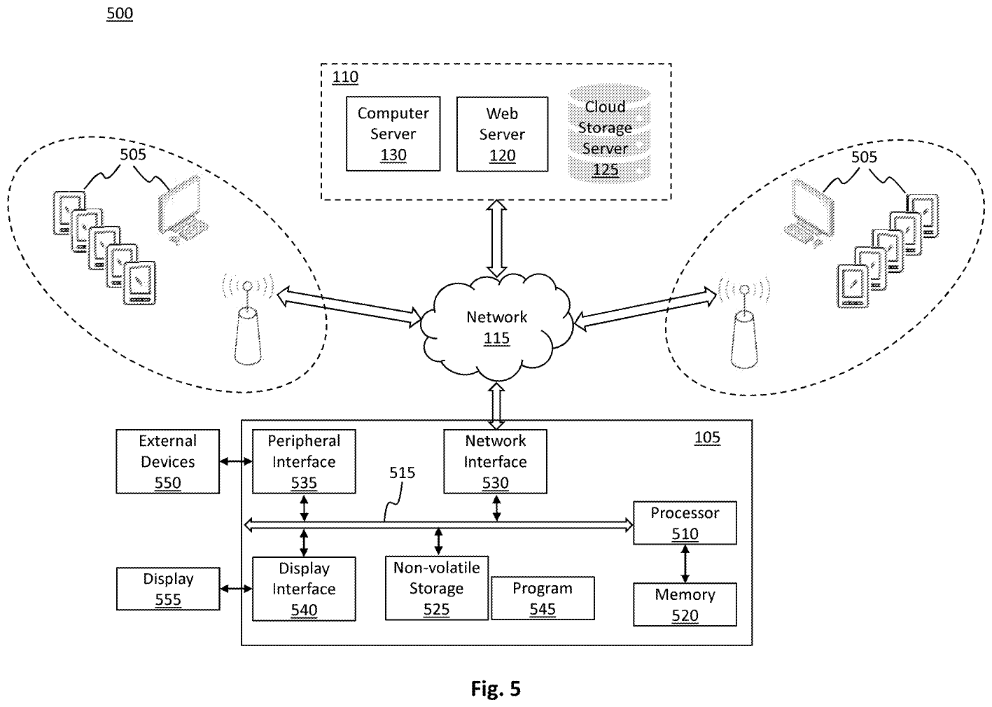

FIG. 5 is a functional block diagram illustrating user device 105 connected to a networked system 500 of one or more networked computers and servers. In an embodiment, the hardware and software environment illustrated in FIG. 5 may provide an exemplary platform for implementation of the software and/or methods according to the present disclosure.

According to some embodiments, a networked system 500 may include, but is not limited to, user device 105, network 115, remote computer 505, web server 120, cloud storage server 125 and computer server 130. Additionally, it should be appreciated that user device 105 can represent one or more of the remote computer 505, web server 120, cloud storage server 125 and computer server 130.

Additional details of user device 105 is shown in FIG. 5. The functional blocks illustrated within user device 105 are provided only to establish exemplary functionality and are not intended to be exhaustive. And while details are not provided for remote computer 505, web server 120, cloud storage server 125 and computer server 130, these other computers and devices may include similar functionality to that shown for user device 105.

User device 105 may be a personal computer (PC), a desktop computer, laptop computer, notebook computer, tablet computer, netbook computer, a personal digital assistant (PDA), a smart phone, or any other programmable electronic device capable of communicating with other devices on network 115.

User device 105 may include processor 510, bus 515, memory 520, non-volatile storage 525, network interface 530, peripheral interface 535 and display interface 540. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 510 may be one or more single or multi-chip microprocessors, such as those designed and/or manufactured by Intel Corporation, Advanced Micro Devices, Inc. (AMD), Arm Holdings (Arm), Apple Computer, or the like. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 515 may be a proprietary or industry standard high-speed parallel or serial peripheral interconnect bus, such as ISA, PCI, PCI Express (PCI-e), AGP, and the like.

Memory 520 and non-volatile storage 525 may be computer-readable storage media. Memory 520 may include any suitable volatile storage devices such as Dynamic Random Access Memory (DRAM) and Static Random Access Memory (SRAM). Non-volatile storage 525 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 545 may be a collection of machine-readable instructions and/or data that is stored in non-volatile storage 525 and is used to create, manage and control certain software functions that are discussed in detail elsewhere in the present disclosure and illustrated in the drawings. In some embodiments, memory 520 may be considerably faster than non-volatile storage 525. In such embodiments, program 545 may be transferred from non-volatile storage 525 to memory 520 prior to execution by processor 510.

User device 105 may be capable of communicating and interacting with other computers via network 115 through network interface 530. Network 115 may be, for example, a local area network (LAN), a wide area network (WAN) such as the Internet, or a combination of the two, and may include wired, wireless, or fiber optic connections. In general, network 115 can be any combination of connections and protocols that support communications between two or more computers and related devices.

Peripheral interface 535 may allow for input and output of data with other devices that may be connected locally with user device 105. For example, peripheral interface 535 may provide a connection to external devices 550. External devices 550 may include devices such as a keyboard, a mouse, a keypad, a touch screen, and/or other suitable input devices. External devices 550 may also include portable computer-readable storage media such as, for example, thumb drives, portable optical or magnetic disks, and memory cards. Software and data used to practice embodiments of the present disclosure, for example, program 545, may be stored on such portable computer-readable storage media. In such embodiments, software may be loaded onto non-volatile storage 525 or, alternatively, directly into memory 520 via peripheral interface 535. Peripheral interface 535 may use an industry standard connection, such as RS-232 or Universal Serial Bus (USB), to connect with external devices 550.

Display interface 540 may connect user device 105 to display 555. Display 555 may be used, in some embodiments, to present a command line or graphical user interface to a user of user device 105. Display interface 540 may connect to display 555 using one or more proprietary or industry standard connections, such as VGA, DVI, DisplayPort and HDMI.

As described above, network interface 530 provides for communications with other computing and storage systems or devices external to user device 105. Software programs and data discussed herein may be downloaded from, for example, remote computer 505, web server 120, cloud storage server 125 and computer server 130 to non-volatile storage 525 through network interface 530 and network 115. Furthermore, the systems and methods described in this disclosure may be executed by one or more computers connected to user device 105 through network interface 530 and network 115. For example, in some embodiments the systems and methods described in this disclosure may be executed by remote computer 505, computer server 130, or a combination of the interconnected computers on network 115. Mobile applications, subscription website data, datasets and/or databases employed in embodiments of the systems and methods described in this disclosure may be stored and or downloaded from one or more of the remote computer 505, web server 120, cloud storage server 125 and computer server 130.

In some embodiments, the opinion polling system 110 may be configured to interact with other service providers of the user to send notifications via one or more digital communication services (e.g., e-mail, SMS, text, voice mail, social media posts, or the like). Such notifications may provide an internet link to the opinion polling system 110 at which a recipient of the notification can view the poll summary 210. If desired, the recipient can register with the opinion polling system 110 and participate in the poll. As such, the polls can be exposed to people who are not yet registered with the opinion polling system 110 prior to receiving the notification. In this manner, users go to the polls and demographic data of those users is captured which can be utilized in future polls and avoids the users from having to enter their demographic data for every poll. As such, an increased sample size may be obtained with the potential of millions of people who can easily access the polls themselves. With an increased sample size, more responses can be captured from a more diverse audience. As such, the raw data from the results of the polling provides consistent reliable polls and mathematical models and algorithms are not necessary to extrapolate results from incomplete polling data.

The control aspects and computational aspects of the present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C #, or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The quantitative polling methods described herein include multiple data points (e.g., total votes, polling votes broken down by answer, number of likes and dislikes, or the like). Qualitative data is also available through user commentary on each poll. As such, qualitative and quantitative polling methods can be used together allowing for an interactive, engaging, and robust polling experience.

Enabling opinion polling through social media can expand the audience to a diverse group of individuals which can be reflected in the demographic data collected and displayed in the response distribution values 415. Furthermore, since users of the mobile application are anonymous, they are much more likely to respond to a poll with honesty. This contributes to poll accuracy as well by removing biases such as social desirability bias, habituation bias, sponsor bias, confirmation bias, culture bias, and the like.

The methods of polling described herein also use technology to leverage the polling process and the subscription costs and pay-per-row data exports allow for a flexible and inexpensive method of polling that significantly reduces costs of polling as compared to traditional forms (e.g., phone banking, door-to-door canvassing, and focus group surveys). People wishing to find a variety of opinion polls and raw polling data can come to the mobile application and/or the subscription website to view and export results from a single location for polling information making for a convenient method to aggregate such polling data. For example, a user can quickly identify aggregate data of a certain number of polls of the same type (e.g., top ten trending polls). In addition, the user is able to view the breakdown of common polls by category. Any user of the polling methods described herein can post polls to determine opinions to important questions. The polling system is capable of interacting with social media to aggregate data across many users and demographics. As such, the polling systems described herein provide an alternative to traditional polling services (e.g., Nielsen ratings, call centers, door-to-door canvassing, and focus groups).

The mobile application and subscription website also allow users to view polling results in real-time or near real-time. As such, trends and opinions can be timely tracked avoiding delays inherit in traditional methods of polling. To support polling research, the subscription site users, according to the methods described herein, are allowed to export poll results along with each vote's associated demographic information. This allows for on-demand polls to be quickly deployed and easily exported to meet the demand of current events. Active polls can be set for a specific time period (e.g., 7 days) and live data can be downloaded in real-time as well as data from archived polls. When users post polls that get downloaded by subscription site users, the user who posted the poll gets cash rewards based on the purchase price of the data. For example, the cash rewards can be a percentage of the price-per-row charged for the downloaded data.

The methods disclosed herein also allow for quantifiable and reliable means of measuring a user's impact on a social media community. Determining the users' final strength scores as disclosed herein allows for robust authentication of genuine users and allows the system to identify bot accounts and bot activity with a high degree of certainty and ensures a high quality of polling data that is both qualitative and quantitative. As such, pollsters purchasing polling data can avoid paying for meaningless or irrelevant data generated by bots.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

In the above descriptions any processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another, or may be combined in various ways. All possible combinations and sub-combinations are intended to fall within the scope of this disclosure.

1. A polling method comprising:
posting a poll in a polling system;
receiving responses to the poll from users of the polling system;
posting a summary of the responses to the poll in the polling system;
exporting purchased data to a purchaser of the data;
calculating a strength rating for a user associated with posting the poll; and
making a payment to the user associated with posting the poll, the payment being calculated based in part on the strength rating.

2. The polling method of claim 1, wherein posting a poll further comprises:
selecting a target demographic of users of the polling system for the poll to be viewed by; and
determining a degree of matching for the target demographic of the responses received.

3. The polling method of claim 2, wherein the target demographic is a geographical region selected by the user.

4. The polling method of claim 2 further comprises:
calculating a price for the purchased data is based on the degree of matching for the target demographic.

5. The polling method of claim 1 further comprises:
calculating a bot score for a response to the poll; and
identifying the response as having been generated by a bot.

6. The polling method of claim 5 further comprises:
excluding the response identified as having been generated by a bot from the summary of responses to the poll.

7. A polling system, comprising:
a user account storage for storing account data associated with users of the polling system;
a polling data storage for storing poll data associated with users of the polling system; and
a web server having one or more processing circuits configured to:
host a poll posted by a user of the polling system;
store responses to the poll in the polling data storage in association with account data of the user who posted the poll;
screen the responses to determine whether a bot had submitted a response;
indicate that a response has been submitted by a bot based on a determination made from screening the response;
post a summary of the responses to the poll in the polling system; and
export purchased data to a user device of a purchaser of the data.

8. The system of claim 7, wherein the one or more processing circuits are further configured to:
calculate bot scores for the responses; and
make the determination based on a bot score of the response.

9. The system of claim 8, wherein the one or more processing circuits are further configured to:
calculate bot scores based on one or more user parameters associated with the responses, wherein the user parameters include:
a number of comments posted, a number of re-posts, a number of likes, a number of dislikes, a number of categories followed, a frequency of polling, a frequency of commenting, and a number of followers.

10. The system of claim 7, wherein the one or more processing circuits are further configured to:
exclude the response identified as having been generated by a bot from the summary of responses to the poll.

11. The system of claim 7, wherein the one or more processing circuits are further configured to:
calculate a strength rating for a user associated with posting the poll; and
make a payment to the user associated with posting the poll, the payment being calculated based on the strength rating.

12. The system of claim 7, wherein the one or more processing circuits are further configured to:
limit viewing of the poll to users that match a target demographic; and
determine a degree of matching for the target demographic of the responses received.

13. The system of claim 12, wherein the target demographic is a geographical region selected by the user that posted the poll.

14. The system of claim 12, wherein the one or more processing circuits are further configured to:
calculate a price for the purchased data based on the degree of matching for the target demographic.

15. A non-transitory computer readable medium for a polling system, which when executed on a user device, causes the user device to:
authenticate a user of the device as a subscriber to the polling system;
display a menu for entering criteria for a poll, the criteria for the poll including a target demographic of users of the polling system permitted to view the poll;
post the poll to the polling system;
display a summary of responses to the poll, the summary including an indicator for a degree to which the other users match the target demographic; and
receiving a payment calculated based on the degree to which the other users match the target demographic and a volume of data from the poll purchased by another user of the polling system.

16. The non-transitory computer readable medium of claim 15, wherein the target demographic is a geographical region selected by the user.

17. The non-transitory computer readable medium of claim 15, which when executed on a user device, further causes the user device to:
display a strength rating for a user associated with posting the poll, wherein the payment is calculated based in part on the strength rating.

18. The non-transitory computer readable medium of claim 15, which when executed on a user device, further causes the user device to:
update, in near real-time, the displaying of the summary of responses and the indicator for the degree to which the other users match the target demographic.

19. The non-transitory computer readable medium of claim 15, which when executed on a user device, further causes the user device to:
send a notification to other user devices using a digital communication service associated with the user device to allow the poll to be displayed on the other user devices.

20. The non-transitory computer readable medium of claim 19, wherein the digital communication service is one of a simple message system (SMS) service, an e-mail service, and a social media service.
